(19) United States
(12) Patent Application Publication
(10) Pub. No.: US 2004/0211032 A1
(43) Pub. Date: Oct. 28, 2004

(54) Consealed sliding hinge

(76) Inventor: Richard Joseph Rojic, Lombard, IL (US)

Correspondence Address: RICHARD J. ROJIC Sr., 228 W. EDWARD St., LOMBARD, IL, 60148, US

(21) Appl. No.: 10/419,633

(22) Filed: Apr. 22, 2003

(51) Int. Cl. E05D 15/00

(52) U.S. Cl. 16/87 R

(57) ABSTRACT

A simple and novel way to retain or mount cabinet doors to main body of cabinet or frame of one kind or other, doors can be opened or slide to left or right side of cabinet or to a center point of cabinet. Doors can be removed from cabinet completely by simply lifting from slide rail. Doors of cabinets are mounted with pivot pin and rails so no hardware is exposed on the outside of cabinet doors. Mounting of slide hinge will be easier and simpler than mounting of standard hidden hinges on the market today. Cost is much less expensive. The cabinet being neater looking all around with versatile door opening.

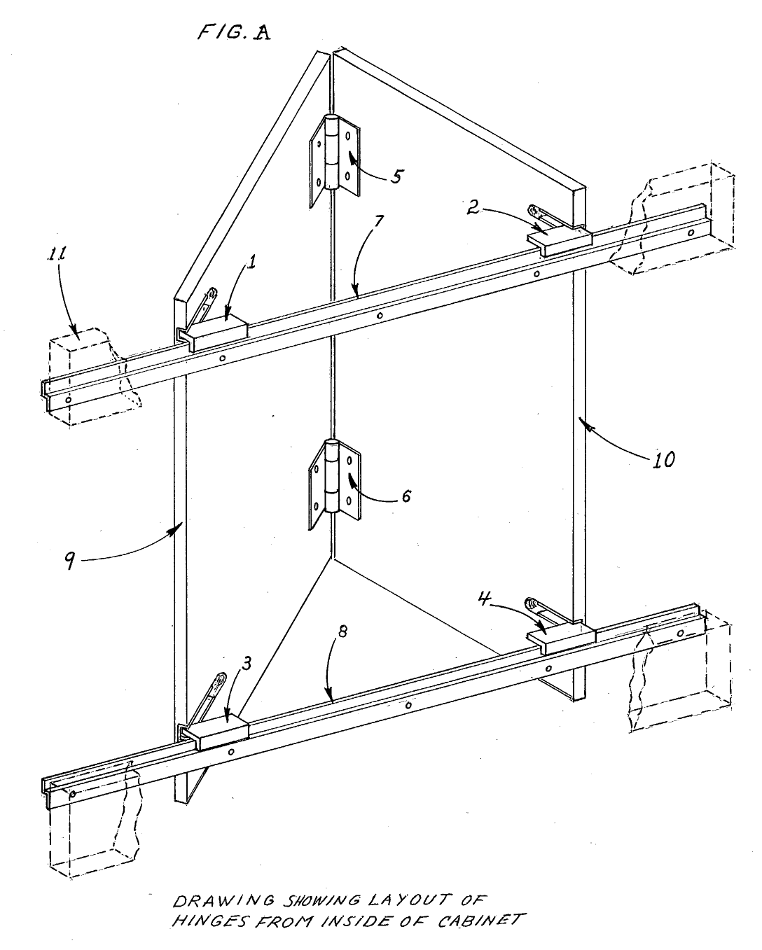

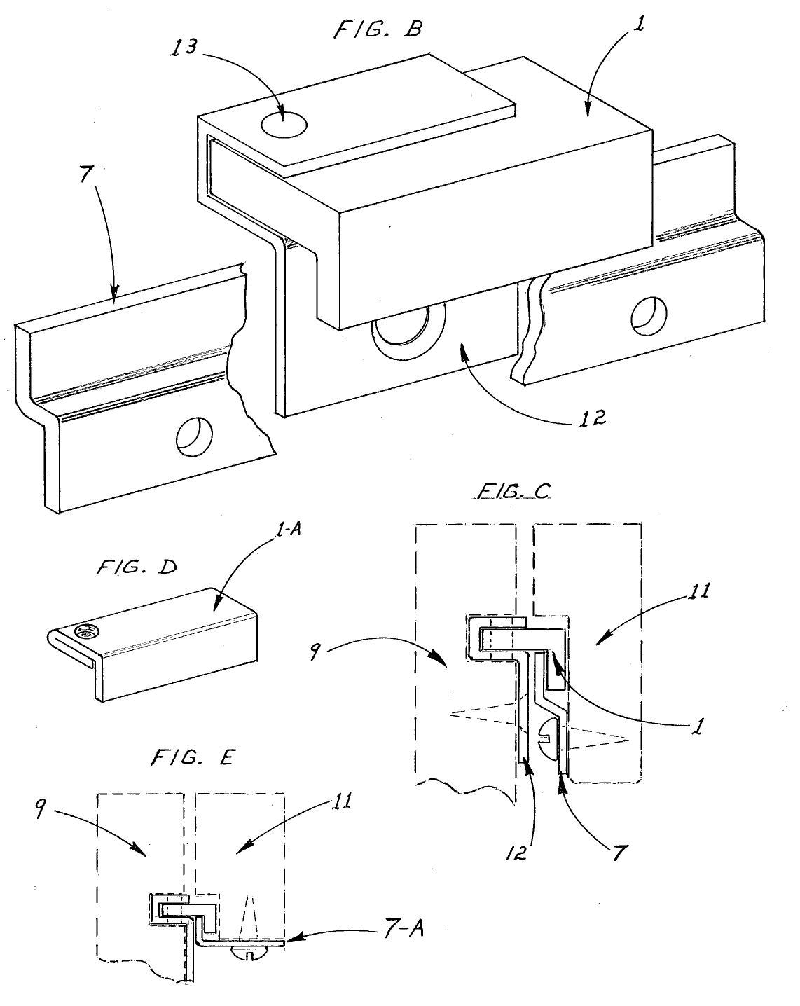

### SUMMARY OF THE INVENTION

This invention relates generally to cabinet doors and apparatus of type which two straight off set shaped rails or angle shaped rails are mounted with wood screws to top and bottom of cabinet frame. Clearance is cut into wood frame to create room for rails. This will also allow clearance for slide member of the hinge to maintain proper depth. This will also permit as little clearance between cabinet face and inside of cabinet doors. Hinges will be mounted on inside of doors. Slot will be cut into inside face of doors; hinges will be seated into slot. Only one wood screw will be used to mount hinge to door. This will retain hinge in a sturdy solid fashion. As doors are pulled out or pushed in pivot pins allow doors to move side ways down the rails in any direction. As doors are moving the pivot pins along rails causing doors to draw closed. Doors can be pushed to either one end of rails or the other end of rails. Using length of slide member in relation with pivot pins in this apparatus is an important feature keeping doors up right at all times. It is the primary object of the present invention to produce a hinge primarily adopted for kitchen cabinets. This new hinge and rail system will permit cabinet builders to mount hinges occupying less space and being so formed as to present a smooth streamlined appearance in all positions the hinge is moved.

### BRIEF DESCRIPTION OF THE DRAWINGS

FIG-A is a diagrammatic plan view of hinge and rails mounted to wood frame of cabinet. Drawing shows layout of hinge from inside of cabinet. Doors are shown in a half way open position.

FIG-B is a isometric projection of the hinge in the closed position riding on rail. Parts include pivot pin, door hinge retainer plate, slide member of hinge and slide guide rail.

FIG-C is end view of hinge in closed position. Showing hinge fastened to door and rail fastened to frame of cabinet.

FIG-D this drawing of slide member of hinge stamped or manufactured from steel in place of plastic.

FIG-E this drawing was added to show slide guide rails as angle shaped members fastened from bottom side of cabinet frame.

### DETAILED DESCRIPTION OF THE HINGE AND MOUNTING

Pivot axis of hinges 5 & 6 are mounted to doors 9 & 10 to create a by fold type action of doors with pivot axis 5 & 6 inside of doors. Door hinge retainer plate 12 is mounted into a slot cut into doors to create pivot axis 13 inside corner of doors. Hinge retainer plate 12 is mounted even with edge of door in a slot with only one screw to hold hinge plate 12 in place, no adjusting needed. Slide member of hinges 1-2-3-4 will pivot on axis 13 of hinge plate 12. Slide members 1-2-3-4 will be retained at a certain distance from slide rails 7&8 so doors can move along rails 7 & 8 freely. Rails 7 & 8 will be screwed to frame 11 with a screw every six inches or so. Frame of cabinet 11 will be cut or sawed to create a clearance in the wood to fasten rails 7 & 8. This cut out or inset will give room so slide member of hinges 1-2-3-4 can slide freely back and forth on rails 7 & 8. When doors 9 & 10 are pulled outward slide member of hinge 1 will rotate on axis 13 and cause doors to move in a linier motion on rails 7 & 8. When doors 9 & 10 are pushed inward doors will automatically close and butt end to end. Hinge door retainer plate 12 this member of the hinge will be formed or stamped from sheet medal of a substantial gauge to retain the weight of wood doors of size required. Pivot pin 13 this pin will be made of steel. Slide member of hinge 1 will be molded or extruded and made of a low friction high impact type of plastic. Slide member 1-A can be used in place of plastic. It will be formed from sheet medal then casehardened. Top and bottom slide rails 7 & 8 will be formed from sheet steel rolled or stamped, 16 or 17-gauge sheet medal should be sufficient. Length of rails 7 & 8 can be from 4 feet to any length desired by manufacturer.

I claim:

1. My hinge is unique in the way I combine pivot axis on by fold of doors to work in relation with pivot axis of hinges with pivot axis imbedded inside edge of doors. Using a three point axis the doors are maintained and held in a upright position as they slide along rails.

2. By insetting hinge retainer plate down into a slot on inside edge of doors. This creates a pivot axis back inside corners of doors. Plus creating a proper clearance for doors to slide and butt each other at their closing position.

3. By inserting hinge retainer plate into a slot in door, this feature lets all doors that are Placed on same slide rail be hung in exact parallel straight line. Plus hinge plate only needs one screw to hold hinge solid in slot.

4. By using rails that are mounted to cabinet face, this makes it simple to add new doors to old used cabinets. Screw rails to face of old cabinets and just hang doors in rails, you're finished.
